(19) United States
(12) Patent Application Publication
(10) Pub. No.: US 2001/0003192 A1
(43) Pub. Date: Jun. 7, 2001

(54) Servicing of linked applications in a client-server environment

(76) Inventors: Nigel James Ramsay, Avalon (NZ); Christopher Michael Walley, Christchurch (NZ)

Correspondence Address: Ronald L Drumheller, Esq., 94 Teakettle Spout Road, Mahopac, NY, 10541, US

(21) Appl. No.: 09/732,345

(22) Filed: Dec. 7, 2000

(30) Foreign Application Priority Data
Dec. 7, 1999 (JP) 11-347660

(51) Int. Cl. G06F 15/16

(52) U.S. Cl. 709/245; 709/203

(57) ABSTRACT

Methods and apparatus at servicing-linked applications in a client-server environment are disclosed. A client 20 is in communication with a server 30, and both are running a main application (in one form a goods and services ordering application). An associated application (for example, On-Line Help) is supported by a second server 30′. When OLH is invoiced on the client 20, a unique identifier is passed to the main application server 30, which locates a corresponding URL string and passes the string to a browser 130 on the client 20. The browser 130 passes the URL to the OHL server 30′ where the respective OLH document is retrieved from a datastore 40, and returned to the client 20 for display on the screen 100.

### FIELD OF THE INVENTION

This application relates to client-server computing systems. The invention relates particularly to linked applications, residing on separate server machines, that service a client machine. In one specific, non-limiting form the two linked applications can be a main application and an associated On-Line Help application.

### BACKGROUND OF THE INVENTION

Taking the case of an On-Line Help (OLH) application by way of example, reference can be had to Published Japanese Application No. JP 10-254593 (International Business Machines Corporation), published on Sep. 25, 1998. This reference discloses an OLH system that operates in conjunction with a web browser. The help function is contained within the information downloaded from the web page being viewed. When “Help” is invoked, a ‘help window’ is displayed, presenting the user with various options. This OLH arrangement can thus be characterized as limited to supporting single web-based applications (i.e. implemented by single URLs), with the help information being contained (or coded) into the HTML code (e.g. JavaScript).

In the environment of multiple servers servicing a plurality of clients, and operating linked applications, it is desirable for the client machine not be over-burdened in managing the linked applications. It is an object of the present invention to avoid such a disadvantage.

### SUMMARY OF THE INVENTION

The invention discloses a client-server computing system servicing linked applications, comprising:

a first server processor machine, running an application program;

a second server processor machine running a linked application and holding a store of records; and

a client processor machine, in data communication with said first and second servers by a network, and also running said application program, said client machine including a display and a Graphical User Interface (GUI) having a plurality of indicia by which application program operations and said linked application program requests can be effected by a user, indicia relating to said linked application having assigned a unique identifier (ID); and

wherein, upon a user making a said linked application request via a said indicium, said client machine passes said ID to said first server machine said server machine converts said ID to a form compatible with said second server and returns said converted ID to said client machine, that, in turn, passes said converted ID to said second server to retrieve a respective stored record therefrom to be provided to said GUI of said client machine.

The invention further discloses a client-server computing system servicing a main application and a linked On-Line Help (OLH) application, comprising:

a first server processor machine, running said main application and a browser program;

a second server processor machine, running said OLH application and holding a store of text records;

a client processor machine, in data communication with said fist and second servers by a network, and also running said main program, and further including a display and a Graphical User Interface (GUI) having a plurality of indicia by which main application program applications and OLH program operations can be effected by a user, indicia relating to said linked application having assigned a unique identifier (ID), and running a browser program; and

wherein, upon a user making an OLH request via a said indicium, said client machine passes said ID to said first server machine, said first server machine converts said ID to a URL and passes said URL to said client machine browser that, in turn, passes said URL to said second server machine browser which retrieves the respective text record for that URL, said second server machine browser returning said text record to said client machine browser, and said client machine browser causing the text record to be displayed by said GUI.

The invention yet further discloses a method for servicing a linked application request in a client-server environment, in which a client processor machine and a first server processor machine run an application program, and a second server processor machine runs said linked application program, the method comprising the steps of:

making a linked application request via an indicium of a Graphical User Interface (GUI), said indicium having assigned a unique identifier (ID):

passing said ID to said first server machine to be converted into a form compatible with said second server;

returning said converted ID to said client machine;

said client machine passing said converted ID to said second server;

said second server retrieving a respective stored record therefrom and returning said stored record to said client machine.

Advantageously, the ID is an alphanumeric value, and the converted ID can be a URL. WinHelp file identifier or Lotus Notes™ address. The second server respectively runs a web browser, WinHelp program or Lotus Notes™ program

### BRIEF DESCRIPTION OF THE DRAWINGS

Embodiments of the invention will now be described with reference to the accompanying drawings, in which:

FIG. 1 is a representative topology of a three tier computing system having external links;

FIG. 2 shows a Graphical User Interface having a Help ID field;

FIG. 3 is a block diagram showing the mapping of software applications to the hardware topology of FIG. 1; and

FIG. 4 is an object interaction diagram.

### DESCRIPTION OF PREFERRED EMBODIMENTS AND BEST MODE

In modern large computing systems a common topology has three tiers: (i) a presentation tier characterized by multiple workstations focusing on user interactions, (ii) a business tier characterized by multiple servers executing application/business logic, and (iii) a data tier characterized by multiple databases working on data storage and organization. A Local or Wide Area Network (LAN/WAN) interconnects the three tier elements.

Such computing systems find application in many and varied fields ranging from university research and teaching facilities to business applications. In fact, almost every business will utilise such a system to transact its functions and serve its clients. For example, a system may be used to control inventory, for word processing and accounts purposes, and for servicing client enquires. Many businesses have very large client bases and may provide an extensive inventory of goods and services. One illustrative example is a telecommunications service provider (Telco) that serves a countrywide client base. The Telco's subscribers thus can number in the millions, and each customer will expect an immediate response from a Customer Service Representative (CSR) to any inquiry. which can range from billing information, a request for a new service, or the placing of orders for a product.

Similar examples are seen in Utilities, insurance companies, banks, hospitals, law firms, accountancy firms, stock exchanges, universities, and Government agencies, to name but a few.

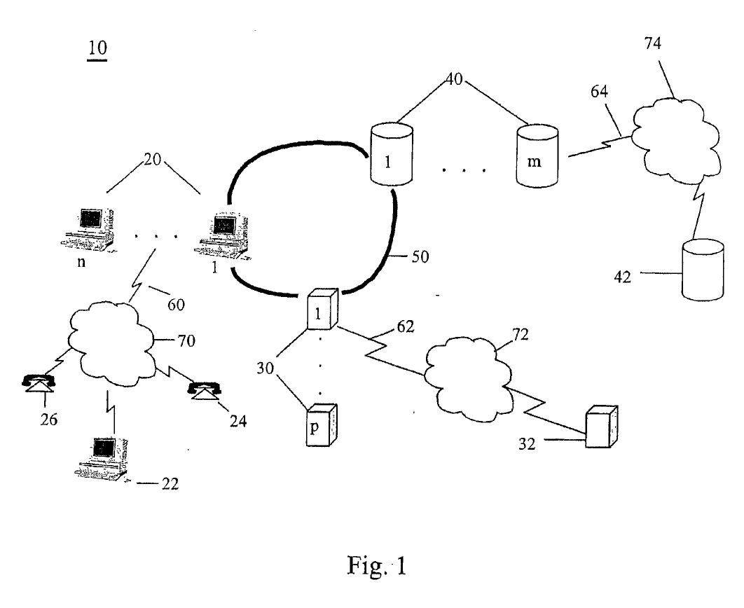

FIG. 1 is a representative topology of a three tier computing system 10. The presentation (or client/user) tier is represented by a number (1 . . . n) of workstations 20, that can be appropriate computing terminals, for example personal computers. The business tier is represented by a number (1 . . . p) of servers 30, that can be dedicated mini or mainframe computers. The data tier is represented by a number (1 . . . m) of databases 40, which can include dynamically managed magnetic or optical storage media.

The computing system 10 is of an ‘open’ design, providing communication links 60,62,64, via external networks 70,72,74 to like-devices 22,32,42 and remote telephone terminals 24, 26.

The workstations 20, servers 30, and databases 40 are interconnected by a Local or Wide Area Network (LAN or WAN) 50. The Network 50 carries information passing between each of the three basic elements described. It will be appreciated that the topology shown in FIG. 1 is representative only, and that any other convenient form of network could be implemented to achieve the objective of information passing between the workstations 20, servers 30, and databases 40.

In the context of the present invention, users of the client workstations 20 will be presented with a Graphical User Interface (GUI), typically panels with click-on buttons, by which application program operations can be effected.

For the purposes of instruction, the example to be described relates to an On-line Help (OLH) application linked with a Goods and Services Ordering (GSO) application. This specific example should be understood to be non-limiting.

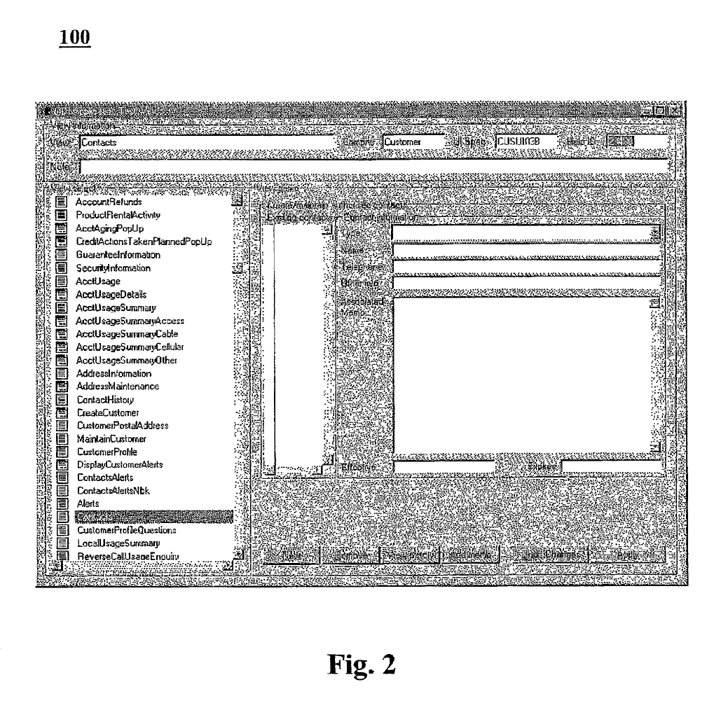

FIG. 2 shows a window 100 for the GSO application. The user is able to select one of the large number of ‘views’. The “Contacts” view has been highlighted and appears in the upper-most panel. In use of the GSO application, the user can enter data or make an enquiry relevant to the contacts functionality. Associated with the Contacts enquiry is a unique “Help ID”, shown as: “23430”. This Help ID is specific to the Contacts view. Each of the selectable views (i.e. AccountRefunds, ProductRentalActivity, etc) has a unique Help ID.

If the user is uncertain, or wishes to check an aspect of the Contacts function, then a linked OLH application can be invoked. This can be achieved by use of a keyboard function key (e.g. PF1) or by another discrete GUI panel (not shown in FIG. 2).

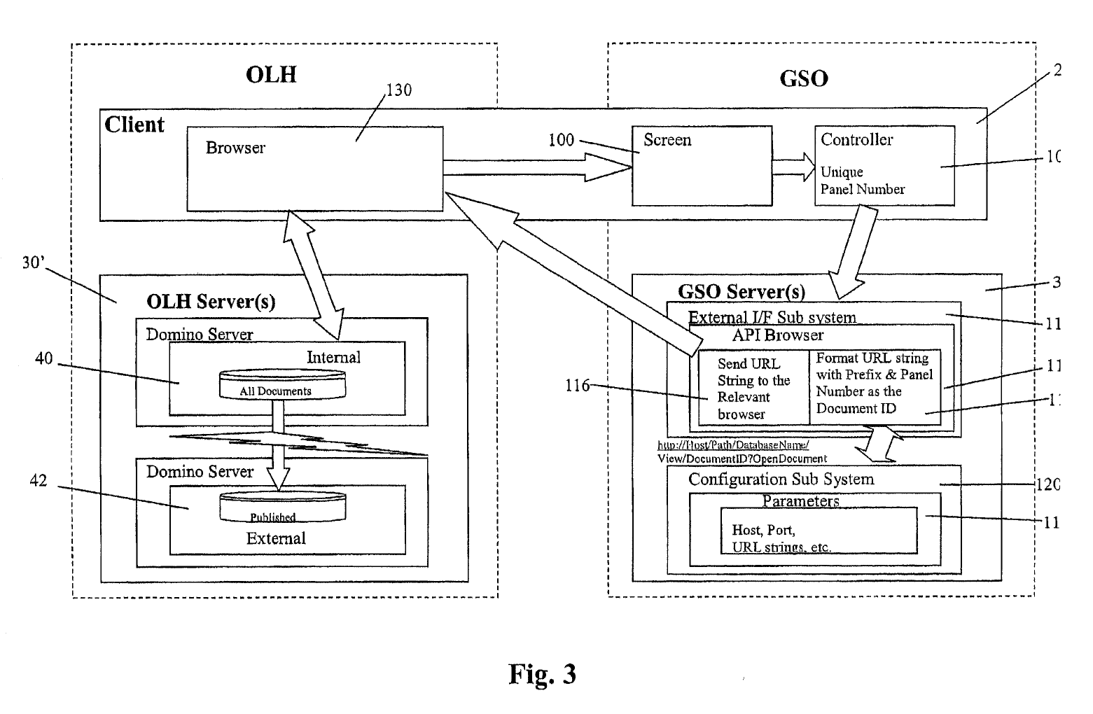

FIG. 3 shows, in schematic terms, the relationship of a single client workstation 20 with two servers 30, 30′. The first server 30 is running the GSO application. The second server 30′ is running the OLH application. The GSO and the OLH applications are linked in the sense described above. Functionality relating to the GSO application is also resident on the client workstation 20. Further, functionality relating to the OLH application also resides on the client workstation 20.

The data transactions occurring between the client workstation 20 and the GSO server 30 in the usual execution of the Goods and Services Ordering functionality have not been shown for reasons of clarity. Rather, only the transactions that occur between the client and server machines when the OLH function is invoked have been shown.

The screen 100 displays a view relating to the GSO application (eg. Contacts). When the OLH function is invoked, a message is passed from the screen 100 to the controller element 102. The controller 102 packages the Help ID number (e.g. 23430) and passes it across the LAN 50 to the external interface subsystem 110 of the GSO server 30. Within the I/F subsystem 110 resides an Application Programming Interface browser application 112. The API browser 112 has a processing part 114 and a communications part 116. The processing part 114 decodes the Help ID and searches a parameter database 118 that resides within a configuration subsystem 120. The parameter database 118 returns information relating to the linked OLH server application to the processing part 114. In other words, the processing part 114 retrieves data in the correct format that points to the location of the information corresponding to the Help ID held by the OLH server 30′. In that case, the configuration subsystem 120 must have pre-existing knowledge of the form in which the OLH information is stored on the OLH server 30′. This can be dealt with in an initial configuration phase.

An example of the parameters residing in the parameters database 118 is as follows:

WebHelpHosts:localhost

WebHelpExe: x:\\Program Files\\Broswer Directory\\Browser.exe

WebHomeURL:

http://%user%%password%@%host%/path/database.nsf/view/document?opendo

cument&login

current&Login

WebHelpURL:

http://%host%/path/database.nsf/view/%topicid%?opendocument

In the present case, the information retrieved from the parameter store 118 identifies a particular host, a communications port and URL strings relating to the OLH server 30′ holding the OLH information for the Help ID No. 23430. This information is passed to the communications part 116 and, in turn, passed to a browser 130 residing on the client workstation 20.

The browser 30 then passes the URL string to the OLH server 30′ where it is received by the data store 40 (located within a Domino™ server). The URL locates the OLH document corresponding to the Help request, and returns that document to the browser 130. The browser, in turn, passes the text to the screen 110 to be displayed to the user. The OLH server 30′ may additionally access a remote data store 42 to locate the OLH document.

An example of a Java Applet for passing the URL and returning the HTML text is as follows:

<APPLET CODE=“com.ibm.cmp.framework. browser.Help”

CODEBASE=“/”ARCHIVE=“external.jar”WIDTH=0 HEIGHT=0>

<PARAM NAME=port VALUE=“998”>

<PARAM NAME=frame VALUE=“Frame2b>

<PARAM NAME=security VALUE=“yes”>

<PARAM NAME=debug VALUE=“true”>

Applet not active

</APPLET>

From the client workstation point of view, all that is required is for it to retain a library of unique Help IDs relating to the panels of the GSO application, and otherwise to act as conduit for the URL returned by the GSO server 30 from which it retrieves the Help text from the OLH server 30′.

The present example describes a browser-based solution. It is possible for the linked OLH server to support other forms, such as Lotus Notes™ or WinHelp™ forms.

For a Lotus Notes™ implementation, the client machine browser 130 would be required to support Lotus Notes™. The OLH server 30′ would be running a Lotus Notes™ application. Additionally, the GSO server 30, in its API browser 112 and parameter store 118 would need to be configured to support Lotus Notes™ message types.

A Win Help™ application requires each of the client browser 130, the OLH server 30′ and the GSO server 30 to support such a format.

It is possible for all three formats to be supported, in a single implementation, requiring each of the client workstation 20, the GSO server and the OLH server 30′ to be able to discriminate between data types.

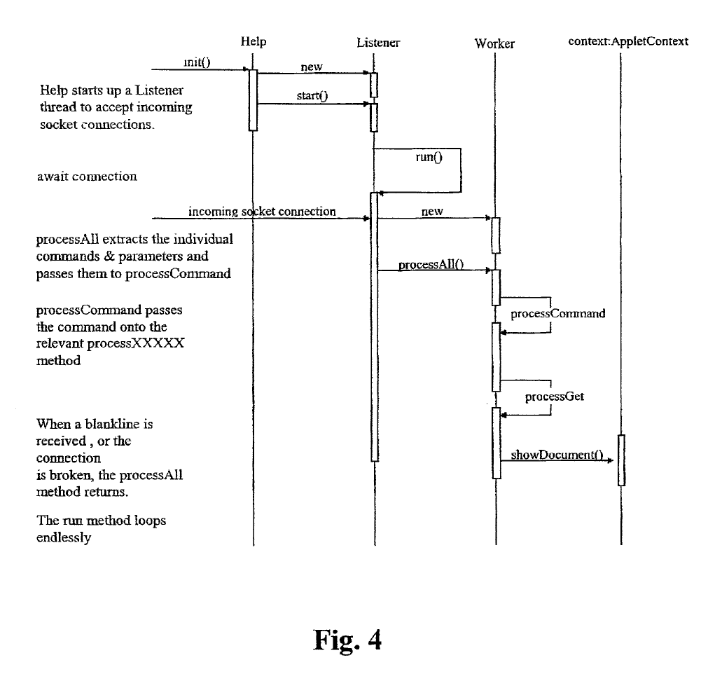

FIG. 4 is an object interaction diagram showing the dynamic nature of the significant interactions implementing the methodology described above. It commences with the passing of the URL string to the browser 130. The communications part 116 attempts to communicate with the Java applet on the browser 130 by opening a TCP socket connection to a predefined port number. If it is the first time that the OLH functionality has been requested, then there will be no Java applet running on the browser, and the socket connection request will fail. The GSO server 30 accordingly instructs the operating system of the client workstation 20 to load a predefined web page in the browser 130 that has the Java applet embedded in it. In one embodiment, it starts up Netscape™, passing the web page as its command line parameter. The communications part 116 attempts a TCP socket connection applet every 500 ms. When the web page loads, the Java applet is initialised.

Following initialization, the applet creates a separate thread “Listener” to service any incoming OLH requests. The Listener thread creates a “Server Socket” which awaits any incoming connections. Once “Server Socket” is active, the URL string is sent. FIG. 4 shows that the URL is parsed such that individual commands and parameters are extracted and passed to a “processCommand” of the Worker (i.e. the OLH server 30′). In turn, the command is passed to the relevant process method, in this case “processGet”. Finally, the “processAll” returns the document as an applet context.

The present invention is advantageous in that the GSO server and the client workstation 20 are not burdened with the load of help libraries that otherwise might reduce performance of the main OLH application. There also is a reduction in purpose-written programming by use of existing compact programs that do not require interaction or complex interactions with the main application.

Another form of linked application that can be supported by the invention is the playing of a video record. Rather than a user requesting a Help function, there could be an equivalent “ShowMe” button on the screen 100. When activated, the same process of identifying the respective URL string is performed, and rather than retrieving a document for the OLH application, an AVI (movie) file can be retrieved. In such an instance, the browser 130 can be such as the Windows™ Media Player. Other possible associated applications include the downloading and running of a Lotus™ ScreenCam movie, to play an audio recording, or to send an e-mail message.

It will be appreciated by those skilled in the art that numerous alterations and modifications can be made without departing from the inventive concepts described. All such modifications and alterations are to be understood as incorporated herein.

We claim:

1. A client-server computing system servicing linked applications comprising:
a first server processor machine running an application program;
a second server processor machine running a linked application and holding a store of records; and
a client processor machine, in data communication with said first and second servers by a network, and also running said application program, said client machine including a display and a Graphical User Interface (GUI) having a plurality of indicia by which application program operations and said linked application program requests can be effected by a user, indicia relating to said linked application having assigned a unique identifier (ID); and
wherein, upon a user making a said linked application request via a said indicium, said client machine passes said ID to said first server machine, said server machine converts said ID to a form compatible with said second server and returns said converted ID to said client machine, that, in turn, passes said converted ID to said second server to retrieve a respective stored record therefrom to be provided to said GUI of said client machine.

2. The system of claim 1, wherein the client machine displays the retrieved record is displayed on said display be said GUI.

3. The system of claim 1, wherein said linked application is an On-Line Help application.

4. The system of claim 1, wherein the retrieved record is reproduced on the client machine by audio means.

5. The system of claim 1, wherein said ID is an alphanumeric value, said converted ID is a URL, and said second server runs a Web Browser.

6. The system of claim 1, wherein said ID is an alphanumeric value, said converted ID is a WinHelp file identifier, and said second server runs a WinHelp program.

7. The system of claim 1, wherein said ID is an alphanumeric value, said converted ID is a Lotus Notes address, and said second server runs a Lotus Notes program.

8. A client-server computing system servicing a main application and a linked On-Line Help (OLH) application, comprising:
a first server processor machine, running said main application and a browser program;
a second server processor machine, limiting said OLH application and holding a store of text records;
a client processor machine, in data communication with said fist and second servers by a network, and also running said main program, and further including a display and a Graphical User Interface (GUI) having a plurality of indicia by which main application program applications and OLH program operations can be effected by a user indicia relating to said linked application having assigned a unique identifier (ID), and running a browser program; and
wherein, upon a user making an OLH request via a said indicium, said client machine passes said ID to said first server machine, said first server machine converts said ID to a URL and passes said URL to said client machine browser that, in turn, passes said URL to said second server machine browser which retrieves the respective text record for that URL, said second server machine browser returning said text record to said client machine browser, and said client machine browser causing the text record to be displayed by said GUI.

9. A method for servicing a linked application request in a client-server environment, in which a client processor machine and a first server processor machine run an application program, and a second server processor machine runs said linked application program, the method comprising the steps of:
making a linked application request via an indicium of a Graphical User Interface (GUI), said indicium having assigned a unique identifier (ID);
passing said ID to said first server machine to be converted into a form compatible with said second server;
returning said converted ID to said client machine;
said client machine passing said converted ID to said second server;
said second server retrieving a respective stored record therefrom, and returning said stored record to said client machine.

10. The method of claim 9, comprising the further step of said client machine displaying said retrieved record by said GUI.

11. The method of claim 10, comprising the further step of reproducing said retrieved record by audio means.
